(19) United States
(12) Patent Application Publication
(10) Pub. No.: US 2015/0294350 A1
(43) Pub. Date: Oct. 15, 2015

(54) AUTOMATED OPTIMIZATION OF A MASS POLICY COLLECTIVELY PERFORMED FOR OBJECTS IN TWO OR MORE STATES AND A DIRECT POLICY PERFORMED IN EACH STATE

(71) Applicant: International Business Machines Corporation, Armonk, NY (US)

(72) Inventors: Hideyuki Mizuta, Tokyo (JP); Rikiya Takahashi, Tokyo (JP); Takayuki Yoshizumi, Tokyo (JP)

(21) Appl. No.: 14/748,318

(22) Filed: Jun. 24, 2015

Related U.S. Application Data
(63) Continuation of application No. 14/644,519, filed on Mar. 11, 2015.

(30) Foreign Application Priority Data
Mar. 27, 2014 (JP) 2014-067160

(51) Int. Cl. G06Q 30/02; G06Q 10/06

(52) U.S. Cl. CPC G06Q 30/0244; G06Q 10/067

(57) ABSTRACT

An information processing apparatus that optimizes a policy in a transition model in which the number of targeted objects in each state transits according to the policy includes a cost constraint acquisition unit configured to acquire a cost constraint that constrains a total cost of the policy; a mass policy setting unit configured to set the number of objects targeted by a mass policy in each state, based on the predefined number of objects to belong to each state and a reach rate at which the mass policy reaches to an object, with respect to the mass policy collectively executed for the object in two or more states; and a processing unit configured to assume the reach rate of the mass policy as a variable of an optimization and maximize an objective function based on a total reward in a whole period while satisfying the cost constraint.

### DOMESTIC AND FOREIGN PRIORITY

This application is a continuation of U.S. patent application Ser. No. 14/644,519, filed Mar. 11, 2015, which claims priority to Japanese Patent Application No. 2014-067160, filed Mar. 27, 2014, and all the benefits accruing therefrom under 35 U.S.C. §119, the contents of which in its entirety are herein incorporated by reference.

### BACKGROUND

The present invention relates generally to information processing techniques and, more particularly, to automated optimization of a mass policy collectively performed for objects in two or more states and a direct policy performed in each state.

There is known a technique of formulating a record such as past sales performance by Markov decision process or reinforcement learning and optimizing the future policy (Non-patent Literatures 1 and 2 and Patent Literatures 1 and 2). However, according to the known method, although it is possible to optimize a direct marketing policy (hereinafter referred to as “direct policy”) that specifies the target of a direct mail or the like, it is not possible to optimize a mass marketing policy (referred to as “mass policy”) such as a television commercial for many and unspecified targets at the same time.

Patent Literature 1 - JP2010-191963A

Patent Literature 2 - JP2011-513817A

Non-patent Literature 1 - A. Labbi and C. Berrospi, Optimizing marketing planning and budgeting using Markov decision processes: An airline case study, IBM Journal of Research and Development, 51(3):421-432, 2007.

Non-patent Literature 2—N. Abe, N. K. Verma, C. Apt'e, and R. Schroko, Cross channel optimized marketing by reinforcement learning, In Proceedings of the 10th ACM SIGKDD Conference on Knowledge Discovery and Data Mining (KDD 2004), pages 767-772, 2004.

### SUMMARY

In one embodiment, an information processing apparatus that optimizes a policy in a transition model in which the number of targeted objects in each state transits according to the policy includes a cost constraint acquisition unit configured to acquire a cost constraint that constrains a total cost of the policy; a mass policy setting unit configured to set the number of objects targeted by a mass policy in each state, based on the predefined number of objects to belong to each state and a reach rate at which the mass policy reaches to an object, with respect to the mass policy collectively executed for the object in two or more states; and a processing unit configured to assume the reach rate of the mass policy as a variable of an optimization and maximize an objective function based on a total reward in a whole period while satisfying the cost constraint.

In another embodiment, an information processing method of optimizing a policy in a transition model in which the number of objects in each state transits according to the policy, the method being executed by a computer, includes a cost constraint acquisition stage of acquiring a cost constraint that constrains a total cost of the policy; a mass policy setting stage of setting the number of objects targeted by a mass policy in each state, based on the predefined number of objects to belong to each state and a reach rate at which the mass policy reaches to an object, with respect to the mass policy collectively executed for the object in two or more states; and a processing stage of assuming the reach rate of the mass policy as a variable of an optimization and maximizing an objective function based on a total reward in a whole period while satisfying the cost constraint.

In another embodiment, a non-transitory computer readable storage medium having instructions stored thereon that, when executed by a computer, implements a processing method of optimizing a policy in a transition model in which the number of objects in each state transits according to the policy. The method includes a cost constraint acquisition stage of acquiring a cost constraint that constrains a total cost of the policy; a mass policy setting stage of setting the number of objects targeted by a mass policy in each state, based on the predefined number of objects to belong to each state and a reach rate at which the mass policy reaches to an object, with respect to the mass policy collectively executed for the object in two or more states; and a processing stage of assuming the reach rate of the mass policy as a variable of an optimization and maximizing an objective function based on a total reward in a whole period while satisfying the cost constraint.

### BRIEF DESCRIPTION OF THE DRAWINGS

FIG. 1 is a block diagram of an information processing apparatus of the present embodiment;

FIG. 2 illustrates a processing flow in the information processing apparatus of the present embodiment;

FIG. 3 illustrates one example of a cost constraint acquired by a cost constraint acquisition unit;

FIG. 4 illustrates one example of a cost function acquired by the cost constraint acquisition unit;

FIG. 5 illustrates the number of objects targeted by a mass policy set by a mass policy setting unit;

FIG. 6 illustrates one example of the distribution of policies output by an output unit;

FIG. 7 illustrates a specific processing flow of the present embodiment;

FIG. 8 illustrates an example of classifying state vectors by a regression tree in a classification unit;

FIG. 9 illustrates an example of classifying state vectors by a binary tree in the classification unit; and

FIG. 10 illustrates one example of a hardware configuration of a computer.

### DETAILED DESCRIPTION

Aspects of the present invention optimize and output policy, including not only a direct policy but also a mass policy.

In a first aspect of the present invention, there is provided an information processing apparatus that optimizes a policy in a transition model in which the number of objects in each state transits according to the policy and that includes: a cost constraint acquisition unit configured to acquire a cost constraint that constrains a total cost of the policy; a mass policy setting unit configured to set the number of objects targeted by a mass policy in each state, based on the predefined number of objects to belong to each state and a reach rate at which the mass policy reaches to an object, with respect to the mass policy collectively executed for the object in two or more states; and a processing unit configured to assume the reach rate of the mass policy as a variable of an optimization and maximize an objective function based on a total reward in a whole period while satisfying the cost constraint.

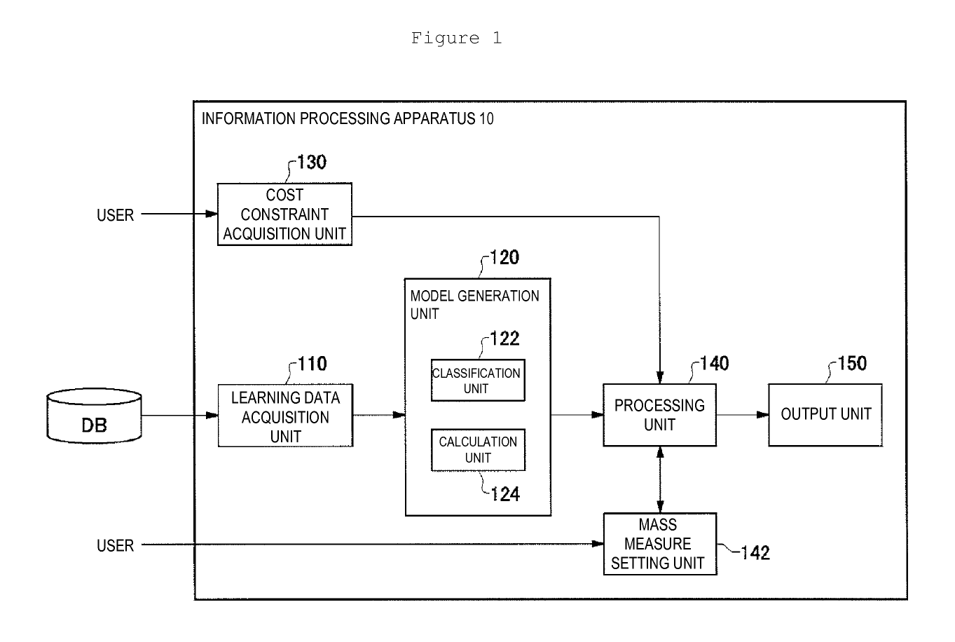

FIG. 1 illustrates a block diagram of the information processing apparatus 10 according to an exemplary embodiment. The information processing apparatus 10 of the present embodiment optimizes a mass policy collectively performed for objects in two or more states and a direct policy performed in each state, taking into account cost constraint over multiple timings and/or multiple states in a transition model in which multiple states are defined and the number of objects in each state (for example, the number of objects classified into each state) transits according to the policy. The information processing apparatus 10 includes a training data acquisition unit 110, a model generation unit 120, the cost constraint acquisition unit 130, a processing unit 140, the mass policy setting unit 142 and the output unit 150.

The training data acquisition unit 110 acquires training data that records reaction to a policy with respect to multiple objects. For example, the training data acquisition unit 110 acquires training data that records policies including a direct policy such as a direct mail and a mass policy such as a television commercial for objects such as multiple consumers, and reaction to a policy such as purchase by the consumers or the like, from a database or the like. The training data acquisition unit 110 supplies the acquired training data to the model generation unit 120.

The model generation unit 120 generates a transition model in which multiple states are defined and an object transits between the states at a certain probability, on the basis of the training data acquired by the training data acquisition unit 110. The model generation unit 120 has a classification unit 122 and a calculation unit 124.

The classification unit 122 classifies multiple objects included in the training data into each state. For example, the classification unit 122 generates the time series of object state vectors on the basis of the reaction and the policies including the direct policy and the mass policy for multiple objects, which are included in the training data, and classifies multiple state vectors into multiple states according to the positions on the state vector space.

The calculation unit 124 calculates a state transition probability representing a probability at which the object of each state transits to each state in multiple states classified by the classification unit 122, and the immediate expected reward acquired when a policy is performed in each state, by the use of regression analysis. The calculation unit 124 supplies the calculated state transition probability and expected reward to the processing unit 140.

The cost constraint acquisition unit 130 acquires multiple cost constraints including a cost constraint that constrains the total cost of the direct policy and/or the mass policy over at least one of multiple timings and multiple states. For example, in a continuous period including one or two or more timings, the cost constraint acquisition unit 130 acquires a budget that can be spent to perform one or two or more direct policies and/or mass policies designated for objects of one or two or more designated states, as a cost constraint.

Moreover, the cost constraint acquisition unit 130 acquires a cost function representing the relationship between the reach rate of the mass policy and the cost of the mass policy. The cost constraint acquisition unit 130 may acquire the cost function every multiple mass segments targeted by the mass policy (for example, segments of consumers who become objects such as a man in his twenties and a woman in her twenties, and so on) and mass policy. The cost constraint acquisition unit 130 supplies the acquired cost constraint and cost function to the processing unit 140.

The processing unit 140 performs optimization of policy distribution only by the direct policy excluding the mass policy. For example, assuming policy distribution about the direct policy excluding the mass policy as a variable of the optimization, the processing unit 140 calculates the direct policy distribution that maximizes the objective function based on the total reward in the whole period. Here, the processing unit 140 maximizes an objective function subtracting a term based on an error between the number of objects targeted by a policy at each timing in each state and the estimated number of objects at each timing in each state based on state transition by a transition model, from the total reward in the whole period, while satisfying multiple cost constraints. The processing unit 140 supplies the calculated policy distribution at each timing in each state to the mass policy setting unit 142 as the predefined number of objects.

Moreover, the processing unit 140 performs optimization of policies including the mass policy and the direct policy. For example, based on the number of objects targeted by a mass policy at each timing in each state received from the mass policy setting unit 142, assuming the reach rate of each mass segment in each timing with respect to the mass policy as a variable of the optimization and assuming policy distribution at each timing in each state with respect to the direct policy as a variable of the optimization, the processing unit 140 maximizes the objective function based on the total reward in the whole period while satisfying the cost constraint. By solving a linear programming problem, and so on, the processing unit 140 acquires a mass policy reach rate to maximize the objective function and the distribution of the direct policy, and supplies them to the output unit 150.

The mass policy setting unit 142 sets the number of objects targeted by a mass policy in each state for optimization of the policies including the mass policy by the processing unit 140. For example, the mass policy setting unit 142 receives the number of objects predefined to belong to each timing and each state excluding the mass policy calculated by the processing unit 140, as a constant, and, based on the predefined number of objects and the reach rate at which the mass policy set by the user reaches an object, sets the number of objects targeted by a mass policy at each timing in each state. The mass policy setting unit 142 supplies the specified number of targeted objects to the processing unit 140.

The output unit 150 outputs the reach rate of the mass policy in each timing every mass segment that maximizes the objective function, and the distribution of the direct policy at each timing in each state. The output unit 150 may display the output result in a display apparatus of the information processing apparatus 10 and/or output it to a storage medium, and so on.

Thus, the information processing apparatus 10 of the present embodiment sets the number of objects targeted by a mass policy on the basis of the number of objects of each state excluding the mass policy, which are received from the processing unit 140 to the mass policy setting unit 142, and calculates a policy including the mass policy in which the processing unit 140 uses the number of objects targeted by a mass policy to maximize the total reward in the whole period.

Especially, since the processing unit 140 includes the distribution of the direct policy optimized beforehand without the mass policy in restriction related to the number of objects by a mass policy as a constant, it is possible to solve an optimization problem of policies including the mass policy as a linear programming problem. By this means, according to the information processing apparatus 10, it is possible to provide an optimization result of the policies including the mass policy.

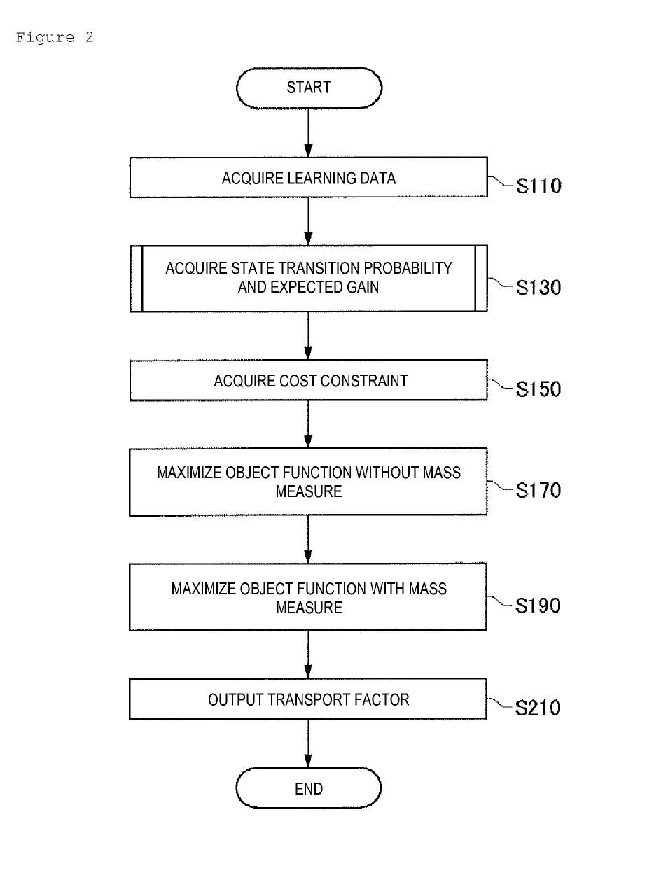

FIG. 2 illustrates a processing flow in the information processing apparatus 10 of the present embodiment. In the present embodiment, the information processing apparatus 10 outputs optimal policy distribution by performing processing in S110 to S210.

First, in S110, the training data acquisition unit 110 acquires training data that records reaction with respect to a policy about multiple objects. For example, the training data acquisition unit 110 acquires the record of a policy and the time series of object reaction including purchase, subscription and/or other responses of commodities or the like by one or multiple objects of a customer, consumer, subscriber and/or cooperation when the policy is executed to give an impulse, as training data.

Here, the training data acquisition unit 110 acquires direct policy “a” (a ∈ A_{D}) for specific objects such as a direct mail and an email, and a mass policy (a ∈ A_{M}) executed for many unspecified ones such as a television commercial, a newspaper and radio, as policy “a” (a ∈ A_{D} ∪ A_{M}). The training data acquisition unit 110 supplies the acquired training data to the model generation unit 120.

Next, in S130, the model generation unit 120 classifies multiple objects included in the training data into each state and calculates the state transition probability and the expected reward in each state and each policy. The model generation unit 120 supplies the state transition probability and the expected reward to the processing unit 140. Here, specific processing content of S130 is described later.

Next, in S150, the cost constraint acquisition unit 130 acquires multiple cost constraints including a cost constraint that restricts the total cost of the direct policy over at least one of multiple timings and multiple states. The cost constraint acquisition unit 130 may acquire a cost constraint that constrains the total cost of multiple direct policies.

For example, the cost constraint acquisition unit 130 may acquire a cost constraint caused by executing the direct policy, such as the constraint of a money cost (for example, the budget amount that can be spent on the policy, and so on), the constraint of a number cost for policy execution (for example, the number of times the policy can be executed, and so on), the constraint of a resource cost of consumed resources or the like (for example, the total of stock biomass that can be used to execute the policy, and so on) and/or the constraint of a social cost of an environmental load or the like (for example, the CO₂ amount that can be exhausted in the policy, and so on), as a cost constraint. The cost constraint acquisition unit 130 may acquire one or more cost constraints and may especially acquire multiple cost constraints.

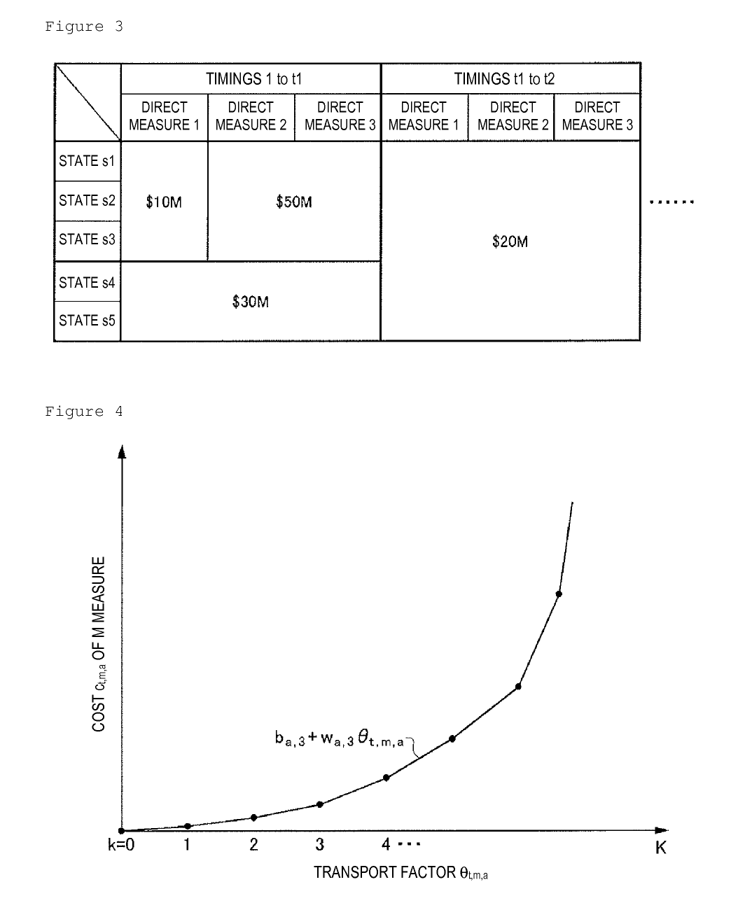

FIG. 3 illustrates one example of a cost constraint acquired by the cost constraint acquisition unit 130. As illustrated in the figure, the cost constraint acquisition unit 130 may acquire a cost constraint defined every period including the whole or partial timing, one or two or more states and one or two or more direct policies.

For example, the cost constraint acquisition unit 130 may acquire 10M dollars as a budget to execute direct policy 1 and 50M dollars as a budget to execute direct policies 2 and 3 with respect to the objects in states s1 to s3 in a period from timing 1 to timing t1, and may acquire 30M dollars as a budget to execute all direct policies with respect to the objects in states s4 and s5 in the same period. Moreover, for example, the cost constraint acquisition unit 130 may acquire 20M dollars as a budget to execute all direct policies with respect to the objects in all states in a period from timing t1 to timing t2.

Moreover, the cost constraint acquisition unit 130 acquires mass policy cost information including the relationship between the mass policy reach rate and the mass policy cost every mass segment. For example, the cost constraint acquisition unit 130 may acquire a cost function representing the relationship between the mass policy reach rate and the mass policy cost, as cost information.

Generally, the cost required for the mass policy gradually increases as reach rate θ of the mass policy becomes closer to 1 (that is, a state in which the mass policy reaches to all objects). For example, when it is presumed that an object such as a consumer stochastically contacts to the mass policy such as a TV advertisement according to the Poisson process of probability x per unit time, θ=1−exp(−x/100)=1−exp(−c/100 uₐ) is established for cost c and reach rate θ of the mass policy. Here, Uₐ stands for the unit price per 1 TRP (Target Rating Point) given from the user. Here, fₐ(θ)=−100 uₐ log(1−θ) is established for actual cost function fₐ(θ).

Here, the cost constraint acquisition unit 130 acquires a cost function approximating actual cost function fₐ(θ) of the mass policy by a piecewise linear function in order to cause the processing unit 140 to optimize a constraint equation related to the mass policy by a linear programming problem or the like.

FIG. 4 illustrates one example of the cost function acquired by the cost constraint acquisition unit 130. The horizontal axis of the graph chart shows reach rate θ_{t,m,a} ∈ [0,1] when mass policy “a” (a ∈ AM) is executed for mass segment m at time t, the vertical axis shows cost c_{t,m,a} required for this mass policy “a”, and a point on the horizontal axis shows sample point θ^{a,k}(k=0, 1, . . . , Ka) of the piecewise linear function to approximate fₐ(θ).

The piecewise linear function has Kₐ intervals and the segment of each interval is represented as b_{a,k}+w_{a, k}θ_{t,m,a. Here, w}_{a,k} stands for the gradient of the piecewise linear function in the interval between sample point θ^{a,k-1} and sample point θ^{a,k}, and b_{a,k} stands for the intercept in θ_{t,m,a}=0 of the piecewise linear function in the interval. As illustrate in the figure, since the piecewise linear function in each segment becomes continuous before and after the sample point, Equation (1) holds.

$${Λ}_{a ∈ {A}_{M}} {{Λ}_{k = 1}}^{{K}_{a} - 1} [ {b}_{a , k} + {w}_{a , k} {θ}^{a , k + 1} = {b}_{a , k + 1} + {w}_{a , k + 1} {θ}^{a , k + 1} ] \qquad Equation 1$$

Since the piecewise linear function becomes a downward convex function, Equation (2) holds.

$${Λ}_{a ∈ {A}_{M}} {{Λ}_{k = 1}}^{{K}_{a} - 1} [ {w}_{a , k} < {w}_{a , k + 1} ] \qquad Equation 2$$

Moreover, since the piecewise linear function has origin θ^{a,0}=0 as a sample point and the value becomes 0 in origin θ^{a,0}, b_{a,1}=0 holds.

The cost constraint acquisition unit 130 acquires information on sample point θ^{a,k}, gradient w_{a,k} and intercept b_{a,k} predefined from the user with respect to a ∈ A_{M} and k ∈ Kₐ, as a cost function.

Next, returning to FIG. 2, in S170, the processing unit 140 maximizes an objective function in policies including only the direct policy and excluding the mass policy. Specifically, the processing unit 140 calculates the value of each variable that maximizes the objective function while satisfying multiple cost constraints, assuming the distribution and error range of the direct policy at each timing in each state as a variable of the optimization.

One example of the objective function that is a maximization object in the processing unit 140 is shown in Equation (3).

$${max}_{π ∈ Π , \{ {σ}_{t , s} \}} [ {\sum }_{t = 1}^{T} {γ}_{1}^{t} {\sum }_{s ∈ S} {\sum }_{a ∈ {A}_{D}} {\hat{n}}_{t , s , a} {\hat{r}}_{t , s , a} - {\sum }_{t = 2}^{T} {\sum }_{s ∈ S} {η}_{t , s} {σ}_{t , s} ] s . t . \\ {Λ}_{s ∈ S} [ {\sum }_{a ∈ {A}_{D}} {n}_{1 , s , a} = {N}_{1 , s} ] \qquad Equation 3$$

Here, γ (0<γ1) represents the predefined discount rate with respect to the future reward, n̂t_{,s,a} represents the number of the targeted objects to which direct policy “a” (a ∈ A_{D}) is distributed in state s at timing t, N_{t,s} represents the number of objects in state s at timing t, r_{̂t,s,a} a represents the expected reward by direct policy “a” (a ∈ A_{D}) in state s at timing t, σ_{t,s} represents the slack variable given by the range of an error between the number of objects targeted by a policy in state s at timing t and the estimated number of objects in state s at timing t according to state transition by a transition model, and η_{t,s} represents a weight coefficient given to slack variable σ_{t,s}.

As shown in Equation (3), when the sum total in all times (t=1, . . . , T) of the value multiplying the sum total in all direct policies “a” (a ∈ A_{D}) and all states s ∈ S of the product of the number of targeted objects n^{̂}_{t,s,a} and expected reward r^{̂}_{t,s,a} by power γ^{t} of the discount rate corresponding to each time t is assumed to be a term based on the total reward in the whole period and the sum total in all states and all times after t=2 of the product of weight coefficient η_{t,s} and slack variable σ_{t,s} is assumed to be a term based on an error, the objective function is acquired by subtracting the term based on the error from the term based on the total reward in the whole period.

Here, Σₐ ∈_{AD}n^{̂}_{1,s,a}=N_{1,s} in Equation (3) defines the sum total in all direct policies “a” (a ∈ A_{D}) of the number of the targeted objects n̂_{t,s,a} to which direct policy “a” is distributed in state s at the start timing (timing 1) of the period, by the number of the targeted objects N_{t,s}. By this means, the processing unit 140 determinately gives the number of objects (for example, population) in each state s at the start timing.

Weight coefficient η_{t,s} may be a predefined coefficient, and, instead of this, the processing unit 140 may calculate weight coefficient η_{t,s} from η_{t,s}s=λγ^{t}Σₐ ∈_{AD)}|r^{̂}_{t,s,a}|.

Here, λ is a global relaxation hyperparameter, and, for example, the processing unit 140 may select k from 1, 10, 10⁻¹10² and 10⁻², and may set optimal k on the basis of the discontinuous state Markov decision process or the result of agent base simulation.

A constraint with respect to slack variable σ_{t,s} that is an optimization target in the processing unit 140 is shown in Equations (4) and (5).

$$\begin{matrix}{{Λ}_{t = 1}}^{T - 1} {Λ}_{s ∈ S} [ {σ}_{t + 1 , s} \geq ( {\sum }_{a ∈ {A}_{D}} {\hat{n}}_{t + 1 , s , a} - {\sum }_{{s}^{′} ∈ S} {\sum }_{{a}^{′} ∈ {A}_{D}} {\hat{p}}_{s \vert {s}^{′} , {a}^{′}} {\hat{n}}_{t , {s}^{′} , {a}^{′}} ) ] & Equation 4 \\ {{Λ}_{t = 1}}^{T - 1} {Λ}_{s ∈ S} [ {σ}_{t + 1 , s} \geq - ( {\sum }_{a ∈ {A}_{D}} {\hat{n}}_{t + 1 , s , a} - {\sum }_{{s}^{′} ∈ S} {\sum }_{{a}^{′} ∈ {A}_{D}} {\hat{p}}_{s \vert {s}^{′} , {a}^{′}} {\hat{n}}_{t , {s}^{′} , {a}^{′}} ) ] & Equation 5\end{matrix}$$

Here, p^{̂}_{sls′,a} represents a state transition probability corresponding to a probability of transition from state s′ to state s when direct policy “a” (a ε A_{D}) is executed.

The equations in parentheses in the right side of inequalities of Equations (4) and (5) show an error between the number of objects targeted by a direct policy at each timing in each state and the estimated number of objects at each timing in each state based on state transition by the transition model.

For example, Σn̂_{t+1,s,a} a denotes the sum total with respect to all direct policies “a” (a ∈ A_{D}) of the number of the objects targeted by direct policy “a” in each state s at one timing t+1. The processing unit 140 actually allocates the number of objects of Σn̂_{t+1,s,a} to a segment in timing t+1 and state s.

Moreover, for example, ΣΣp^{̂}_{sls′,a′}n^{̂}_{t,s′,} denotes the sum total with respect to all states s′ ∈ S and all direct policies a′ of the estimated number of objects calculated by the processing unit 140 by estimating that it transits to one timing t+1 and each state s by state transition based on the distribution of the number of targeted objects n^{̂}_{t,s′,a} and state transition probability p^{̂}_{sls′,a} of direct policy “a” in each states'(s′ ∈ S) of timing t previous to one timing t+1.

That is, the equations in the parentheses on the right side of the inequalities of Equations (4) and (5) represent an error between the number of actual objects existing in timing t+1 and state s and the estimated number of objects estimated by the state transition probability and the number of objects in previous timing t. The processing unit 140 gives the absolute value of the error to lower limit value of slack variable σ_{t,s} , by constraint of the inequalities of Equations (4) and (5). Therefore, slack variable σ_{t,s} increases under the condition that the error is estimated to be large and the reliability of the transition model is estimated to be low.

Here, the processing unit 140 may assume the larger value that is one of 0 and the error as the lower limit value of slack variable σ_{t,s} instead of giving the absolute value of the error to the lower limit value of slack variable σ_{t,s}.

In Equation (3), there is a relationship that the objective function decreases when a term based on the error increases, and the term based on the error increases in proportion to slack variable σ_{t,s}. By this means, the processing unit 140 calculates a condition of balancing the total reward and the degree of reliability at the same time by introducing the low degree of reliability of the transition model into the objective function as a penalty value and maximizing the objective function.

The processing unit 140 maximizes the objective function by further using a cost constraint shown in Equation (6).

$${{Λ}_{i = 1}}^{I} ⌈ {\sum }_{( t , s , a ) ∈ {Z}_{i}} {c}_{t , s , a} {\hat{n}}_{t , s , a} {\geq }_{<} {C}_{i} ⌉ \qquad Equation 6$$

Here, c_{t,s,a} represents a cost in a case where direct policy “a” is executed in state s at timing t, and Cᵢ represents the specified value, upper limit value or lower limit value of the total cost about the i-th (i=1, . . . , I, where “I” denotes an integer equal to or greater than 1) cost constraint. The cost may be predefined every timing t, state s and/or direct policy “a”, or may be acquired from the user by the cost constraint acquisition unit 130.

The processing unit 140 maximizes the objective function by further using the constraints related to the number of objects shown in Equation (7).

$${{Λ}_{t = 1}}^{T} [ {\sum }_{s ∈ S} {\sum }_{a ∈ {A}_{D}} {\hat{n}}_{t , s , a} = N ] \qquad Equation 7$$

Here, N represents the number of total objects (for example, population of all consumers) that is predefined or to be defined by the user.

Equation (7) shows a constraint that the number of objects n^{̂}_{t,s,a} targeted by a direct policy “a” at each timing t in each state s is equal to the predefined number of total objects N. By this means, the processing unit 140 includes a condition that the number of objects targeted by direct policies at all times in all states is always equal to the population of all consumers, in the constraints.

By solving a linear programming problem or mixed integer programming problem including the constraints shown in Equations (3) to (7), the processing unit 140 calculates the numbers of objects n^{̂}_{t,s,a} assigned to each timing t, each state s and each direct policy “a” as direct policy distribution.

Next, the processing unit 140 acquires the number of objects n^{̂}_{t,s} with respect to each timing t and each state s by calculating sum total Σn̂_{t,s,a} with respect to direct policy “a” (a ∈ A_{D}) of calculated direct policy distribution n̂_{t,s,a}. The processing unit 140 supplies acquired the number of objects n^{̂}_{t,s} to the mass policy setting unit 142 as the predefined number of objects.

In S170, by introducing a term related to an error on the number of objects, that is, a term including a slack variable in the objective function that should be maximized, the processing unit 140 can treat a cost constraint over multiple timings, multiple periods and/or multiple states as a problem that can be solved at high speed such as a linear programming problem, and output the policy distribution that gives a big total reward at high accuracy.

Next, in S190, the processing unit 140 optimizes a policy including the mass policy and the direct policy to maximize the objective function. For example, the processing unit 140 maximizes the objective function based on the total reward in the whole period while satisfying the cost constraint, assuming reach rate θ_{t,m,a} every mass segment m at each timing t with respect to mass policy “a” (a ∈ A_{M}) as a variable of the optimization and assuming policy distribution at each timing in each state with respect to the direct policy as a variable of the optimization.

One example of the objective function that should be maximized by the processing unit 140 is shown in Equation (8).

$${max}_{π ∈ Π , \{ {σ}_{t , s} \}} [ {\sum }_{t = 1}^{T} {γ}_{1}^{t} {\sum }_{s ∈ S} {\sum }_{a ∈ {A}_{D} ⋃ {A}_{M}} {n}_{t , s , a} {\hat{r}}_{t , s , a} - {\sum }_{t = 2}^{T} [ {γ}_{2}^{t} {\sum }_{a ∈ {A}_{M}} {\sum }_{m ∈ M} {δ}_{t , m , a} ] ] s . t . \\ {Λ}_{s ∈ S} [ {\sum }_{{A}_{D} ⋃ {A}_{M}} {n}_{1 , s , a} = {N}_{1 , s} ] \qquad Equation 8$$

Here, γ₁ (0<γ₁≦1) represents the predefined discount rate with respect to the future reward, γ₂ (0<γ_{2≦}1) represents the predefined discount rate with respect to the future cost, n_{t,s,a} represents the number of objects to which direct policy “a” (a ∈ A_{D}) and mass policy “a” (a ∈ A_{M}) are distributed in state s at timing t, N_{t,s} represents the number of objects in state s at timing t, r_{̂t,s,a} represents the expected reward by direct policy “a” (a ∈ A_{D}) and mass policy “a” (a ∈ A_{M}) in state s at timing t, and δ_{t,m,a} a represents the slack variable given by the cost function of timing t, mass segment m and mass policy “a”.

As illustrated in Equation (8), when the sum total in all times (t=1, . . . , T) of the value multiplying the sum total in all policies “a” (a ∈ A_{D} ∪ A_{M}) and all states s ∈ S of the product of the number of targeted objects n^{̂}_{t,s,a} and expected reward r^{̂}_{t,s,a} by power γ₁^{t} of the discount rate corresponding to each time t is assumed to be a term based on the total reward in the whole period and the sum total in all times (t=1, . . . , T) of the value multiplying the sum total in all mass segments m and all mass policies “a” (a ∈ A_{M}) of slack variable δ_{t,m,a} by discount rate power 72 is assumed to be a term based on the cost of the mass policy, the objective function is acquired by subtracting the term based on the cost of the mass policy from the term based on the total reward in the whole period.

Here, Σₐ∈ _{AD∪AM}n_{1,s,a}=N_{1,s} in Equation (8) defines the sum total in all policies a ∈ A_{D} ∪ A_{M} of the number of objects n_{t,s,a} to which policy “a” is distributed in state s at the start timing (timing 1) of the period, by the number of targeted objects N_{t,s}. By this means, the processing unit 140 determinately gives the number of objects (for example, population) in each state s at the start timing.

A constraint with respect to slack variable δ_{t,m,a} that is a target of optimization of the processing unit 140 is shown in Equation (9).

$${Λ}_{{t ∈ T}_{m ∈ M}} {Λ}_{a ∈ {A}_{M}} [ {δ}_{t , m , a} \geq {\sum }_{k = 1}^{{K}_{a}} I ( {θ}^{a , k - 1} \leq {θ}_{t , m , a} < {θ}^{a , k} ) ( {b}_{a , k} + {w}_{a , k} {θ}_{t , m , a} ) ] \qquad Equation 9$$

Here, the right side of the inequality of Equation (9) shows a piecewise linear function that approximates the mass policy cost function described in FIG. 4. I(logic) denotes an indicator function that becomes 1 when “logic” holds and becomes 0 when “logic” does not hold, where a term of (b_{a,k}+w_{a,k}θ_{t,m,a}) shows the line segment in each interval of the cost function. Therefore, the right side of the inequality of Equation (9) shows the cost function approximated to the piecewise linear function. According to Equation (9), when reach rate θ_{t,m,a} increases and thereby the cost of the mass policy increases, slack variable δ_{t,m,a} increases too.

In Equation (8), the objective function decreases when a term including the slack variable increases. By this means, the processing unit 140 calculates a condition that the mass policy cost does not become too much and the total reward increases by introducing the degree of the mass policy cost in the objective function as a penalty value and maximizing the objective function.

The processing unit 140 maximizes the objective function by further using the cost constraint about the direct policy shown in Equation (10).

$${{Λ}_{i = 1}}^{I} ⌈ {\sum }_{( t , s , a ) ∈ {Z}_{i}} {c}_{t , s , a} {n}_{t , s , a} {\geq }_{<} {C}_{i} ⌉ \qquad Equation 10$$

Here, c_{t,s,a} represents a cost in a case where direct policy a (a ∈ A_{D}) is executed in state s at timing t, and Ci represents the specified value, upper limit value or lower limit value of the total cost about the i-th (i=1, . . . , I, where “I” denotes an integer equal to or greater than 1) cost constraint. The cost may be predefined every timing t, state s and/or direct policy “a”, or may be acquired from the user by the cost constraint acquisition unit 130. The processing unit 140 may further use a cost constraint about the mass policy.

The processing unit 140 maximizes the objective function by further using a constraint about the number of objects shown in Equation (11).

$${{Λ}_{t = 1}}^{T} [ {\sum }_{s ∈ S} {\sum }_{a ∈ {A}_{D} ⋃ {A}_{M}} {n}_{t , s , a} = N ] \qquad Equation 11$$

Here, N represents the number of total objects (for example, population of all consumers) that is predefined or to be defined by the user.

Equation (11) shows a constraint that the number of objects n_{t,s,a} targeted by all policies a ∈ A_{D} ∪ A_{M} at each timing t in each state s is equal to the predefined number of total objects N. By this means, the processing unit 140 includes a condition that the number of objects targeted by all policies including the direct policy and the mass policy in all states at all times is always equal to the population of all consumers, in the constraints.

The processing unit 140 maximizes the objective function by further using a constraint about the number of objects targeted by each mass policy shown in Equation (12).

$${Λ}_{a ∈ {A}_{M}} [ {n}_{t , s , a} = {\sum }_{m ∈ M} {θ}_{t , m , a} {ϕ}_{m \vert s} {\hat{n}}_{t , s} ] \qquad Equation 12$$

Equation (12) shows a constraint about the number of objects n_{t,s,a} targeted by the mass policies assigned to timing t, state s and mass policy “a” (a ∈ A_{M}). The processing unit 140 acquires the value of the right side in the parentheses of Equation (12) from the mass policy setting unit 142. Here, the calculation method of the value by the mass policy setting unit 142 is described.

The mass policy setting unit 142 sets the predefined number of objects in the mass policy and sets the number of objects n_{t,s,a} targeted by the mass policy in each state on the basis of the result acquired by maximizing the objective function in S170 excluding the mass policy.

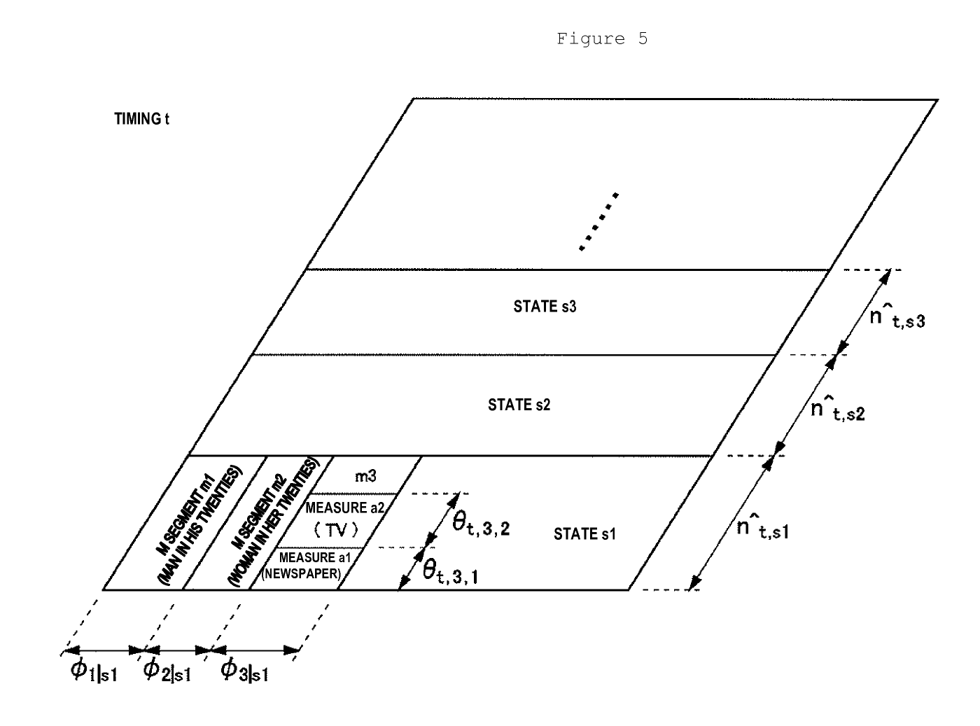

FIG. 5 illustrates the outline of the number of objects n_{t,s,a} targeted by the mass policy set by the mass policy setting unit 142. A quadrangular region in the figure shows all objects (for example, all targeted consumers). As illustrated in the figure, all the objects are divided into multiple states (state s1, state s2 and state s3, and so on). Each state has objects of the predefined number of objects n^{̂}_{t,s} calculated by the processing unit 140 in S170, and, for example, state s1 has objects of the number of objects n^{̂}_{t,s1}, state s2 has objects of the number of objects n^{̂}_{t,s2} and state s3 has objects of the number of objects n^{̂}_{t,s3}.

Each state is divided into multiple mass segments m. For example, each state s is divided into mass segment m1 (for example, man in his twenties), mass segment m2 (for example, woman in her twenties) and mass segment m3 (for example, man in his thirties), and so on. The rate of mass segment m in each state s is represented by mass segment rate φₘₗₛ.

For example, mass segment m1 occupies mass segment rate φ₁ₗₛ₁ in state s1, mass segment m2 occupies mass segment rate φ₁ₗₛ₂ in state s2, and mass segment m3 occupies mass segment rate φ₁ₗₛ₃ in state s1. The mass policy setting unit 142 may acquire mass segment rate φₘₗₛ from the user or may calculate it from past data separately.

In addition, in each mass segment m, the policy reaches to an object at timing t and reach rate θ_{t,m,a} of each mass policy “a”. For example, as illustrated in the figure, in mass segment m3, mass policy al reaches to the object at a rate of reach rate θ_{t,3,1}∈ [0,1] of mass policy al (press advertising) at timing t, and mass policy a2 reaches to the object at a rate of reach rate θt,3,2 of mass policy a2 (press advertising) at timing t.

Reach rate θ_{t,m,a} may be a common value of two or more states s. This is based on a premise that the mass policy reach rate does not depend on object's state s, but depends on mass segment m to which the object belongs.

As shown in the right side of the equality of Equation (12), the mass policy setting unit 142 acquires the number of objects n_{t,s,a} targeted by mass policy “a” with respect to timing t and state s1, by calculating the sum total of all segments m ∈ M with respect to the number of objects θ_{t,m,a}φₘₗₛ₁n^{̂}_{t,s1} targeted by mass policy “a” with respect to segment m1 in state s1 at timing t. The mass policy setting unit 142 sets the number of objects n_{t,s,a} targeted by mass policy “a” in each of the two or more states s.

By solving a linear programming problem or mixed integer programming problem including the constraints shown in Equations (8) to (12), the processing unit 140 acquires the number of objects n_{t,s,a} assigned to each timing t, each state s and each direct policy “a” (a ∈ A_{D}) as direct policy distribution, and acquires reach rate θ_{t,m,a} of each timing t, each segment m and mass policy “a” (a ∈ A_{M}) as a mass policy execution goal.

Here, since φₘₗₛ₁ and n^{̂}_{t,s1} are constants in Equation (12), the processing unit 140 can process Equation (12) as a linear programming problem. The processing unit 140 supplies the calculated policy distribution or the like to the output unit 150.

Here, the information processing apparatus 10 may repeat the processing in S190 predefined times. In this case, the mass policy setting unit 142 sets the predefined number of objects n^{̂}_{t,s1} in the mass policy and sets the numbers of objects targeted by mass policy in each state on the basis of a result acquired by maximizing the objective function by the processing unit 140 in previous S190 while satisfying the cost constraint. For example, the mass policy setting unit 142 may assume the sum total of all policies a ∈ A_{D} ∪ A_{M} of policy distribution n_{t,s,a} with respect to each timing and each state, as the predefined number of objects n^{̂}_{t,s1}.

In the repetition, the processing unit 140 re-executes processing to maximize the objective function while satisfying the cost constraint, assuming reach rate θ_{t,m,a} in each timing with respect to mass policy “a” (a ∈ A_{M}) as a variable of the optimization and assuming policy distribution n_{t,s,a} at each timing in each state with respect to direct policy (a ∈ A_{D}) executed every state as a variable of the optimization. By the repetition processing, the processing unit 140 can improve the accuracy of reach rate θ_{t,m,a} and policy distribution n_{t,s,a}.

Next, in S210, the output unit 150 outputs direct policy distribution _{nt,s,a} that maximizes the objective function, and reach rate θ_{t,m,a} that becomes the goal of the mass policy.

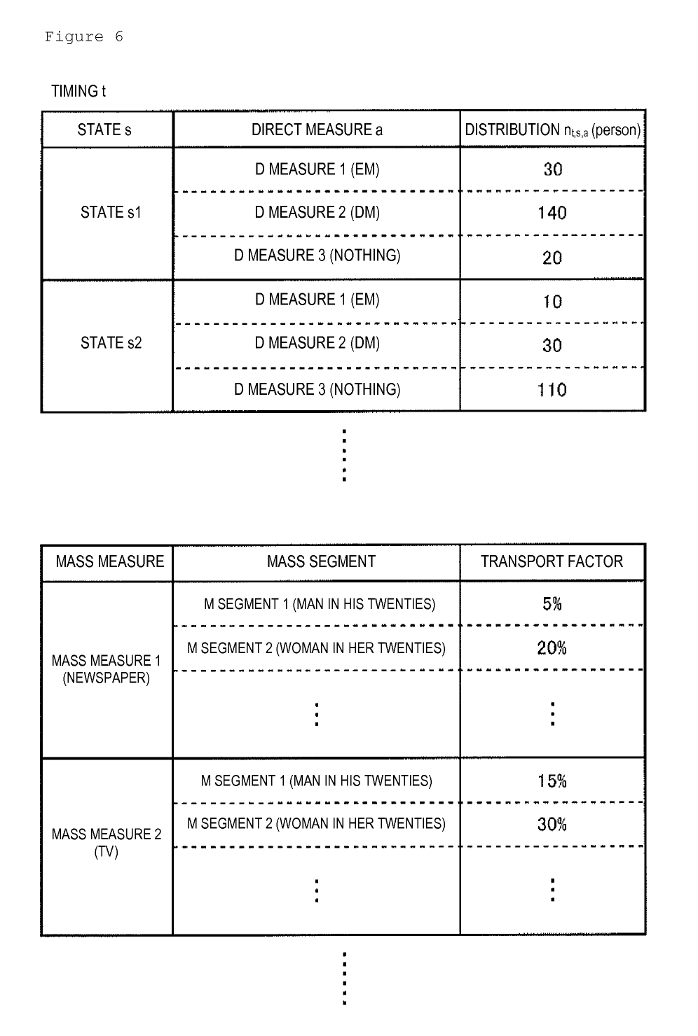

FIG. 6 illustrates one example of the policy distribution and the reach rate which are output by the output unit 150. As illustrated in the figure, the output unit 150 outputs the number of objects n_{t,s,a} targeted by each direct policy “a” at each timing t in each state s.

For example, the output unit 150 outputs policy distribution showing that direct policy 1 (for example, email) is implemented for 30 people, direct policy 2 (for example, direct mail) is implemented for 140 people and direct policy 3 (for example, nothing) is implemented for 20 people among the targeted persons in state s1 at time t. Moreover, the output unit 150 outputs policy distribution showing that direct policy 1 is implemented for 10 people, direct policy 2 is implemented for 30 people and direct policy 3 is implemented for 110 people among targeted persons in state s2 at time t.

The output unit 150 outputs reach rate θ_{t,m,a} of each mass policy “a” in each mass segment m at each timing t. For example, at timing t, it outputs reach rate of 5% with respect to mass segment ml (for example, man in his twenties) of mass policy 1 (for example, press advertising), and reach rate of 20% with respect to mass segment m2 (for example, woman in her twenties). Moreover, for example, it outputs reach rate of 15% with respect to mass segment ml of mass policy 2 (for example, television commercial) and reach rate of 30% with respect to mass segment m2.

Thus, according to the information processing apparatus 10, first, the processing unit 140 calculates the number of objects in each state at each timing when a policy to maximize the total reward in the whole period is executed excluding mass policy, the mass policy setting unit 142 sets the number of objects targeted by mass policy on the basis of the number of objects received from the processing unit 140, and the processing unit 140 calculates a mass policy and direct policy that maximize an objective function subtracting the cost of the mass policy from the total reward in the whole period. By this means, according to the information processing apparatus 10, it is possible to provide the result of optimizing policies including the mass policy at high speed.

Moreover, since the information processing apparatus 10 performs optimization by a linear programming problem or the like, it is possible to solve a problem of an extremely high dimensional model, that is a model having many kinds of states and/or policies. In addition, the information processing apparatus 10 can be easily extended even to a multi-objective optimization problem. For example, in a case where expected reward r_{t,s,a} is not a simple scalar but has multiple values (for example, in the case of separately considering sales of an Internet store and sales of a real store), the information processing apparatus 10 can easily perform optimization by assuming a multi-objective function shown by a linear combination of these values to be an objective function

Here, in the processing in S190, the information processing apparatus 10 may introduce a slack variable defined in a range of an error between the estimated number of objects and the number of targeted objects in the same way as S170, instead of introducing slack variable δ_{t,m,a} about the mass policy cost in a constraint equation as a penalty value. In this case, the mass policy cost may be constrained by Equation (10) about a cost constraint.

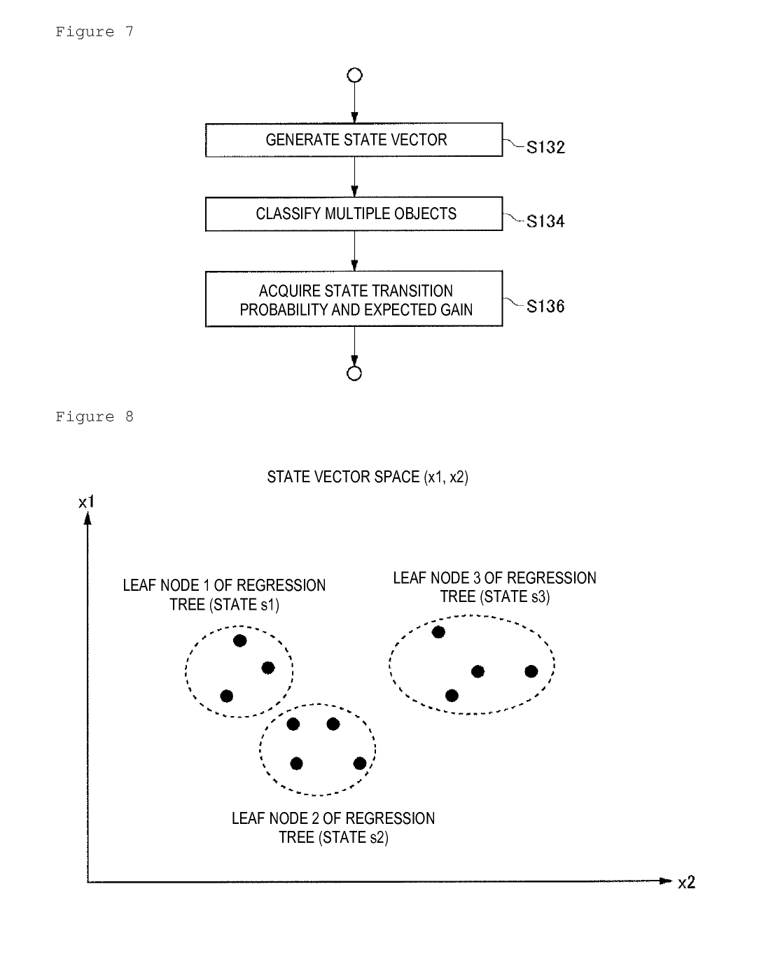

FIG. 7 illustrates a concrete processing flow of S130 of the present embodiment. The model generation unit 120 performs processing in S132 to S136 in the processing in S130.

First, in S132, based on reaction and policies including the direct policy and the mass policy with respect to each of multiple objects included in training data, the classification unit 122 of the model generation unit 120 generates state vectors of the objects. For example, with respect to each of the objects in a predefined period, the classification unit 122 generates a state vector having a value based on a policy executed for the object and/or reaction of the object as a component.

As an example, the classification unit 122 may generate a state vector having: the number of times one certain consumer performs purchase in previous one week, as the first component; the number of times the one consumer performs purchase in previous two weeks, as the second component; the number of direct mails transmitted to the one consumer in previous one week, as the third component; and the value of the product of the average audience rating and the number of times of TV commercials in a mass segment to which the one consumer belongs, as the fourth component.

Next, in S134, the classification unit 122 classifies multiple objects on the basis of the state vectors. For example, the classification unit 122 classifies multiple objects by applying supervised learning or unsupervised learning and suiting a decision tree to a state vector.

As an example of the supervised learning, the classification unit 122 assumes a state vector of one object as input vector x, assumes a vector showing reaction from an object in a predefined period after the time at which the state vector of the one object is observed (for example, a vector assuming the sales of each product recorded during one year from the observation timing of the state vector, as a component), as output vector y, and suits a regression tree in which output vector y can be predicted at highest accuracy. By assigning each state every leaf node of the regression tree, the classification unit 122 discretizes the state vectors according to multiple objects and classifies multiple objects into multiple states.

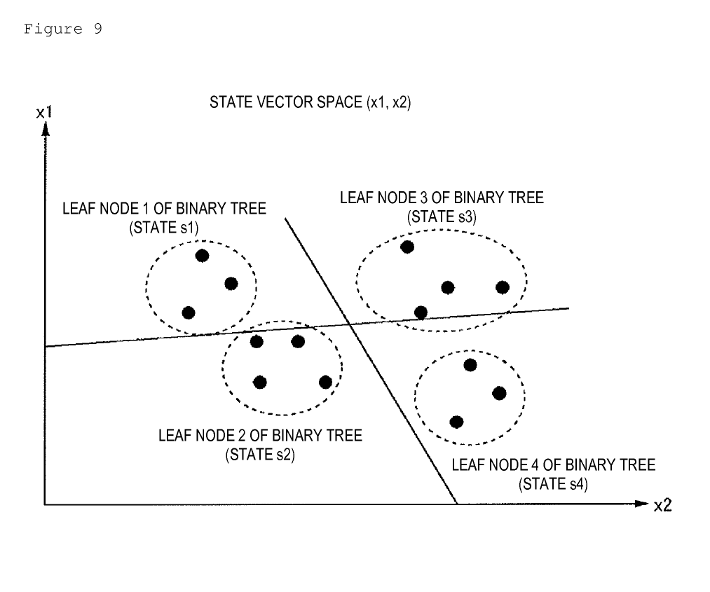

FIG. 8 illustrates an example in which the classification unit 122 classifies the state vectors by the regression tree. Here, an example is shown where the classification unit 122 classifies multiple state vectors having two components of x1 and x2. The vertical axis and horizontal axis of the graph in the figure show the scale of components x1 and x2 of the state vectors, multiple points plotted in the graph show multiple state vectors corresponding to multiple objects, and the regions enclosed with broken lines show the state vector ranges that become conditions included in the leaf nodes of the regression tree.

As illustrated in the figure, the classification unit 122 classifies multiple state vectors into every leaf node of the regression tree. By this means, the classification unit 122 classifies multiple state vectors into multiple states s1 to s3.

As an example of the unsupervised learning, by classifying the state vectors according to multiple objects by an axis by which the variance of the state vectors becomes maximum by a binary tree, the classification unit 122 discretizes the state vectors according to multiple objects and classifies multiple objects into multiple states.

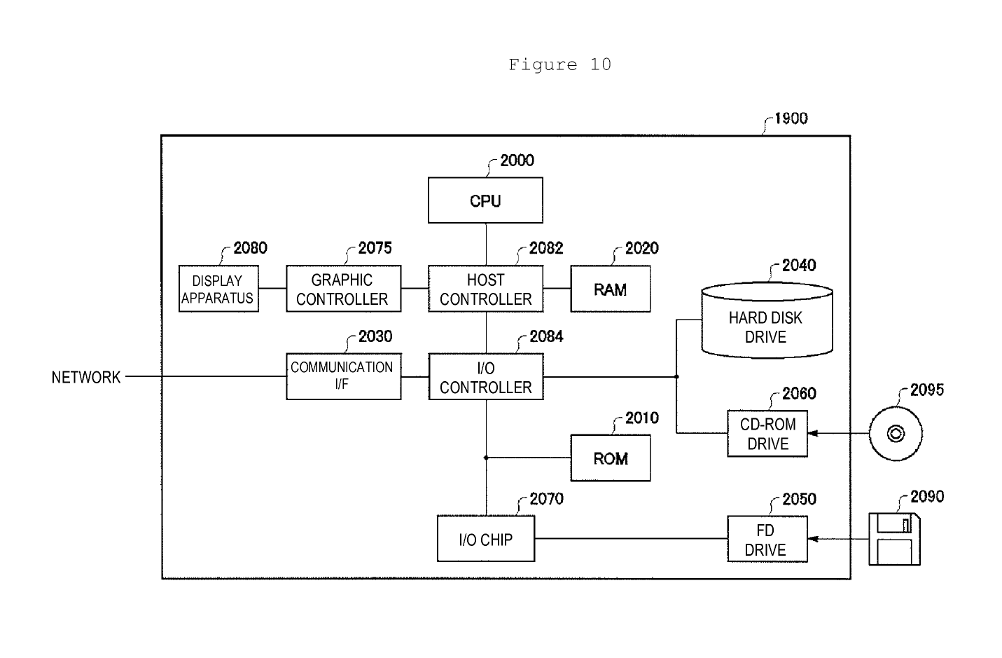

FIG. 9 illustrates an example where the classification unit 122 classifies state vectors by a binary tree. Similar to FIG. 8, the vertical axis and horizontal axis of the graph in the figure show the scale of components x1 and x2 of the state vectors, and multiple points plotted in the graph show the state vectors corresponding to multiple objects.

The classification unit 122 calculates an axis by which, when multiple state vectors are divided by the axis and classified into multiple groups, the total of the variance of the state vectors of all divided groups becomes maximum, and performs discretization by dividing multiple state vectors into two by the calculated axis. As illustrated in the figure, by repeating the division predefined times, the classification unit 122 classifies multiple state vectors according to multiple objects into multiple states s1 to s4.

Returning to FIG. 7, next, in S136, the calculation unit 124 calculates state transition probability p^{̂}_{sls′,a} and expected reward r^{̂}_{t,s,a}. For example, the calculation unit 124 calculates state transition probability p̂_{sls′,a} by performing regression analysis on the basis of to which state the object of each state classified by the classification unit 122 transits according to the policy. As an example, the calculation unit 124 may calculate state transition probability p^{̂}_{sls′,a} by using Modified Kneser-Ney Smoothing.

Moreover, for example, the calculation unit 124 calculates expected reward r^{̂}_{t,s,a} by performing regression analysis on the basis of how much amount of expected reward is given immediately after the object of each state classified by the classification unit 122 executes the policy. As an example, the calculation unit 124 may calculate expected reward r^{̂}_{t,s,a} accurately by the use of L1-regularization Poisson regression and/or L1-regularization logarithmic normal regression. Here, the calculation unit 124 may use the result of subtracting the cost necessary for policy execution from the expected benefit at the time of executing the policy (for example, sales-marketing cost), as an expected reward.

FIG. 10 illustrates one example of a hardware configuration of the computer 1900 that functions as the information processing apparatus 10. The computer 1900 according to the present embodiment includes a CPU periphery having a CPU 2000, a RAM 2020, a graphic controller 2075 and a display apparatus 2080 that are mutually connected by a host controller 2082, an input/output unit having a communication interface 2030, a hard disk drive 2040 and a CD-ROM drive 2060 that are connected with the host controller 2082 by an input/output controller 2084, and a legacy input/output unit having a ROM 2010, a flexible disk drive 2050 and an input/output chip 2070 that are connected with the input/output controller 2084.

The host controller 2082 connects the CPU 2000 and the graphic controller 2075 that access the RAM 2020 at a high transfer rate, and the RAM 2020. The CPU 2000 performs operation on the basis of programs stored in the ROM 2010 and the RAM 2020, and controls each unit. The graphic controller 2075 acquires image data generated on a frame buffer installed in the RAM 2020 by the CPU 2000 or the like, and displays it on the display apparatus 2080. Instead of this, the graphic controller 2075 may include the frame buffer that stores the image data generated by the CPU 2000 or the like, inside.

The input/output controller 2084 connects the communication interface 2030, the hard disk drive 2040 and the CD-ROM drive 2060 that are relatively high-speed input-output apparatuses, and the host controller 2082. The communication interface 2030 performs communication with other apparatuses via a network by wire or wireless. Moreover, the communication interface functions as hardware that performs communication. The hard disk drive 2040 stores a program and data used by the CPU 2000 in the computer 1900. The CD-ROM drive 2060 reads out a program or data from a CD-ROM 2095 and provides it to the hard disk drive 2040 through the RAM 2020.

Moreover, the ROM 2010, the flexible disk drive 2050 and the input/output chip 2070 that are relatively low-speed input/output apparatuses are connected with the input/output controller 2084. The ROM 2010 stores a boot program executed by the computer 1900 at the time of startup and a program depending on hardware of the computer 1900, and so on. The flexible disk drive 2050 reads out a program or data from a flexible disk 2090 and provides it to the hard disk drive 2040 through the RAM 2020. The input/output chip 2070 connects the flexible disk drive 2050 with the input/output controller 2084, and, for example, connects various input/output apparatuses with the input/output controller 2084 through a parallel port, a serial port, a keyboard port and a mouse port, and so on.

A program provided to the hard disk drive 2040 through the RAM 2020 is stored in a recording medium such as the flexible disk 2090, the CD-ROM 2095 and an integrated circuit card, and provided by the user. The program is read out from the recording medium, installed in the hard disk drive 2040 in the computer 1900 through the RAM 2020 and executed in the CPU 2000.

Programs that are installed in the computer 1900 to cause the computer 1900 to function as the information processing apparatus 10 includes a training data acquisition module, a model generation module, a classification module, a calculation module, a cost constraint acquisition module, a processing module, a mass policy setting module and an output module. These programs or modules may request the CPU 2000 or the like to cause the computer 1900 to function as the training data acquisition unit 110, the model generation unit 120, the classification unit 122, the calculation unit 124, the cost constraint acquisition unit 130, the processing unit 140, the mass policy setting unit 142 and the output unit 150.

Information processing described in these programs is read out by the computer 1900 and thereby functions as the training data acquisition unit 110, the model generation unit 120, the classification unit 122, the calculation unit 124, the cost constraint acquisition unit 130, the processing unit 140, the mass policy setting unit 142, and the output unit 150 that are specific means in which software and the above-mentioned various hardware resources cooperate. Further, by realizing computation or processing of information according to the intended use of the computer 1900 in the present embodiment by these specific means, the unique information processing apparatus 10 based on the intended use is constructed.

As an example, in a case where communication is performed between the computer 1900 and an external apparatus or the like, the CPU 2000 executes a communication program loaded on the RAM 2020 and gives an instruction in communication processing to the communication interface 2030 on the basis of processing content described in the communication program. In response to the control of the CPU 2000, the communication interface 2030 reads out transmission data stored in a transmission buffer region installed on a storage apparatus such as the RAM 2020, the hard disk drive 2040, the flexible disk 2090 and the CD-ROM 2095 and transmits it to a network, or writs reception data received form the network in a reception buffer region or the like installed on the storage apparatus. Thus, the communication interface 2030 may transfer transmission/reception data with a storage apparatus by a DMA (direct memory access) scheme, or, instead of this, the CPU 2000 may transfer transmission/reception data by reading out data from a storage apparatus of the transfer source or the communication interface 2030 and writing the data in the communication interface 2030 of the transfer destination or the storage apparatus.

Moreover, the CPU 2000 causes the RAM 2020 to read out all or necessary part of files or database stored in an external storage apparatus such as the hard disk drive 2040, the CD-ROM drive 2060 (CD-ROM 2095) and the flexible disk drive 2050 (flexible disk 2090) by DMA transfer or the like, and performs various kinds of processing on the data on the RAM 2020. Further, the CPU 2000 writes the processed data back to the external storage apparatus by DMA transfer or the like. In such processing, since it can be assumed that the RAM 2020 temporarily holds content of the external storage apparatus, the RAM 2020 and the external storage apparatus or the like are collectively referred to as memory, storage unit or storage apparatus, and so on, in the present embodiment.

Various kinds of information such as various programs, data, tables and databases in the present embodiment are stored on such a storage apparatus and become objects of information processing. Here, the CPU 2000 can hold part of the RAM 2020 in a cache memory and perform reading/writing on the cache memory. In such a mode, since the cache memory has part of the function of the RAM 2020, in the preset embodiment, the cache memory is assumed to be included in the RAM 2020, a memory and/or a storage apparatus except when they are distinguished and shown.

Moreover, the CPU 2000 performs various kinds of processing including various computations, information processing, condition decision and information search/replacement described in the present embodiment, which are specified by an instruction string, on data read from the RAM 2020, and writs it back to the RAM 2020. For example, in a case where the CPU 2000 performs condition decision, it decides whether to satisfy a condition that various variables shown in the present embodiment are larger, smaller, equal to or greater, equal to or less, or equal to other variables or constants, and, in a case where the condition is established (or is not established), it diverges to a different instruction string or invokes a subroutine.

Moreover, the CPU 2000 can search for information stored in a file or database or the like in a storage apparatus. For example, in a case where multiple entries in which the attribute values of the second attribute are respectively associated with the attribute values of the first attribute are stored in a storage apparatus, by searching for an entry in which the attribute value of the first attribute matches a designated condition from multiple entries stored in the storage apparatus and reading out the attribute value of the second attribute stored in the entry, the CPU 2000 can acquire the attribute value of the second attribute associated with the first attribute that satisfies the predetermined condition.

Although the present invention has been described using the embodiment, the technical scope of the present invention is not limited to the range described in the above-mentioned embodiment. It is clear for those skilled in the art to be able to add various changes or improvements to the above-mentioned embodiment. It is clear that a mode in which such changes or improvements are added is included in the technical scope of the present invention, from the description of the claims.

As for the execution order of each processing such as operation, procedures, steps and stages in the apparatuses, systems, programs and methods shown in the claims, specification and figures, terms such as “prior to” and “in advance” are not clearly shown, and it should be noted that they can be realized in an arbitrary order unless the output of prior processing is used in subsequent processing. Regarding the operation flows in the claims, the specification and the figures, even if an explanation is given using terms such as “first” and “next”, it does not mean that it is essential to implement them in this order.

### REFERENCE SIGNS LIST

10 . . . Information processing apparatus

110 . . . training data acquisition unit

120 . . . Model generation unit

122 . . . Classification unit

124 . . . Calculation unit

130 . . . Cost constraint acquisition unit

140 . . . Processing unit

142 . . . Mass policy setting unit

150 . . . Output units

1900 . . . Computer

2000 . . . CPU

2010 . . . ROM

2020 . . . RAM

2030 . . . Communication interface

2040 . . . Hard disk drives

2050 . . . Flexible disk drive

2060 . . . CD-ROM drive

2070 . . . Input/output chip

2075 . . . Graphic controller

2080 . . . Display apparatus

2082 . . . Host controller

2084 . . . Input/output controller

2090 . . . Flexible disk

2095 . . . CD-ROM

1. An information processing method of optimizing a policy in a transition model in which the number of objects in each state transits according to the policy, the method being executed by a computer, the method comprising:
a cost constraint acquisition stage of acquiring a cost constraint that constrains a total cost of the policy;
a mass policy setting stage of setting the number of objects targeted by a mass policy in each state, based on the predefined number of objects to belong to each state and a reach rate at which the mass policy reaches to an object, with respect to the mass policy collectively executed for the object in two or more states; and
a processing stage of assuming the reach rate of the mass policy as a variable of an optimization and maximizing an objective function based on a total reward in a whole period while satisfying the cost constraint.

2. The information processing method of claim 1, wherein, in the mass policy setting stage, the number of objects targeted by the mass policy in each of the two or more states is set, based on the predefined number of objects to belong to each state and the reach rate common in the two or more states, with respect to the mass policy collectively executed for the object in the two or more states.

3. The information processing method of claim 1, wherein:
in the mass policy setting stage, the number of objects targeted by the mass policy in each state at each timing is set, based on the predefined number of objects in each state at each timing and the reach rate at which the mass policy reaches to the object, with respect to the mass policy; and
in the processing stage, the reach rate in each timing with respect to the mass policy is assumed as a variable of an optimization, policy distribution in each state at each timing with respect to a direct policy executed every state is assumed as a variable of an optimization, and the objective function is maximized while the cost constraint is satisfied.

4. The information processing method of claim 3, wherein:
in the processing stage, policy distribution about the direct policy without the mass policy is assumed as a variable of an optimization and policy distribution that maximizes the objective function is calculated;
in the mass policy setting stage, the predefined number of objects in the mass policy is set and the number of objects targeted by the mass policy in each state is set, based on a result acquired by maximizing the objective function excluding the mass policy; and
in the processing stage, the reach rate in each timing with respect to the mass policy is assumed as the variable of the optimization, the policy distribution in each state at each timing with respect to the direct policy executed every state is assumed as the variable of the optimization, and the objective function is maximized while the cost constraint is satisfied.

5. The information processing method of claim 1, wherein:
in the mass policy setting stage, the predefined number of objects in the mass policy is set and the number of objects targeted by the mass policy in each state is set, based on a result acquired by maximizing the objective function while satisfying the cost constraint; and
in the processing stage, the reach rate in each timing with respect to the mass policy is assumed as the variable of the optimization, the policy distribution in each state at each timing with respect to the direct policy executed every state is assumed as the variable of the optimization, and processing to maximize the objective function while satisfying the cost constraint is performed again.
